(19) United States
(12) Patent Application Publication
(10) Pub. No.: US 2002/0077857 A1
(43) Pub. Date: Jun. 20, 2002

(54) Local medication scan code date repository (LMSCDR)

(76) Inventor: Paul Seelinger, San Diego, CA (US)

Correspondence Address: Kenneth F. Florek, Esq., HEDMAN & COSTIGAN, P.C., 1185 Avenue of the Americas, New York, NY, 10036, US

(21) Appl. No.: 10/016,872

(22) Filed: Dec. 14, 2001

Related U.S. Application Data
(60) Provisional application No. 60/255,350, filed on Dec. 15, 2000.

(51) Int. Cl. G06F 17/60

(52) U.S. Cl. 705/2

(57) ABSTRACT

Interactive medication data repository and data management program, and method for providing timely medication data updates via use of a network, such as the Internet. The system and method for providing and managing medication data, including identifying scan codes for bar codes, compliments existing bedside scanning systems and other bar coded enabled hospital systems by providing missing data and communications infrastructure, thereby allowing data sharing that ensures proper medication usage and prevents medication errors.

### REFERENCE TO RELATED APPLICATIONS

This application claims the benefit of U.S. Provisional Application No. 60/255,350 filed Dec. 15, 2000.

### FIELD OF THE INVENTION

This invention is directed to a system that includes a pharmaceutical database containing product data, including data specific to the identification of products by bar code scanning or other electronic means. More particularly, the invention is directed to an institutional level database for two-way communication with locally based bedside scanning, re-packaging, labeling, and compounding/admixture preparation systems. The invention is capable of receiving additions and updates over the Internet.

### BACKGROUND OF THE INVENTION

Medication errors that occur during the delivery of patient care in the institutional setting have been an issue of national and universal concern for decades. Although hospitals and other institutions continuously strive to provide quality patient care, errors resulting in patient injury and death are occurring at significantly high and unacceptable numbers. An Institute of Medicine (IOM) Report, To Err is Human: Building a Safer Health System, called public attention to the important issue of patient safety. Further, the recent focus by the Clinton Administration on medication error prevention has added visibility to this issue. Medication errors are the most common cause of patient injuries in hospitals (see J. W. Kenagy, G. C. Stein, Naming, Labeling and Packaging of Pharmaceuticals, 2001 Amer. J. Health-Syst. Pharm. 58:2033-2041). As health care facilities continue to decrease the number of staff personnel as a cost cutting measure, the possibility of personnel errors will most likely increase.

It is important to recognize that there are many types of medication “errors” and, in accordance, various levels of severity. For example, the administration of an intravenous (IV) solution containing a chemotherapy agent (cancer drug) to the correct patient four hours late and administration of this same chemotherapy IV solution to the wrong patient both constitute an error. In the first case, the error might be considered minor, although still a type of error by definition (given at the wrong time). In the second case, giving the chemotherapy TV solution to the wrong patient is much more serious, and, depending on the circumstances, could cause significant harm or even death to the patient receiving the drug. It is important, therefore, that the healthcare industry have the infrastructure needed to focus not only on reducing the number of errors but also on preventing the most serious errors from occurring.

Confusing drug names, labels, and packages are important sources of medication errors. The Joint Commission on Accreditation of Healthcare Organizations (JCAHO) is focusing on reducing medication errors resulting from confusing look-alike, sound-alike medications. A 2001 report by USP indicates that confusion over drug names accounted for approximately 15 percent of errors reported to USP's Medication Errors Reporting Program (MERP) from January 1996 through December 2000 (e.g. dopaamine with dobutamine). Merely telling health care workers to read labels carefully is unlikely to solve the problem. In fact, product descriptions used by concurrent hospitals systems are often inconsistent, making it even more difficult for caregivers to avoid error. Improved product identification methods are needed.

Some states have issued guidelines to help hospitals reduce medication errors. Others, such as California, have mandated near future implementation of medication error-reduction plans and error reporting systems.

The diversity of causes of errors requires many solutions. The most immediate and far-reaching may be in the area of technology implementation. Patient safety can be improved by information technology through the use of machine-readable codes such as bar codes in a standardized format on all medication packages and containers. Unfortunately, the health care industry has been slow in developing required standards and effective technology to prevent medication errors.

Over 10 years ago, automated pharmaceutical delivery systems began to be developed and marketed to reduce the high rates of medication errors associated with manual medication distribution in hospitals. During the 1990's, several companies developed and launched bar code scanning systems for use by caregivers to help prevent medication errors at the point of care (see Puckett F., Medication Management Component of a Point-of-Care Information System, 1995 Amer. J. Health-Syst. Pharm 52:1305-9). These systems employ a process referred to as “bedside scanning” which requires the caregiver to scan a bar code on his/her hospital ID badge to identify who is administering the medication, the patient's wristband to identify the patient, and the product to be administered/used to insure correctness of the “Five-Rs”, i.e., Right patient for whom the medication is intended, Right medication as ordered by the prescriber for that patient, Right dose as ordered by the prescriber for that patient, Right route of administration as ordered by the prescriber for that patient and/or dictated by FDA product approval, Right time of administration as ordered by the prescriber for that patient (see Hakanson JA et al. Potential Use of Bar Codes to Implement Automated Dispensing Quality Assurance Programs, 1985 Hosp. Pharm. 20:327-37; Meyer GE et al Use of Bar Codes in Inpatient Drug Distribution, 1991 Amer. J. Hosp. Pharm. 48:953-66).

Early adopters of this new technology have reported significant barriers to successful implementation, new potential sources of error, and major infrastructure changes that have been necessary to accommodate the technology. Currently, bedside scanning systems seem to be focused on the development of user hardware, i.e., the handheld or bedside scanning device, rather than the availability of scan code data and the imperative connectivity to other bar code enabled systems. Such systems fail to provide an underlying supporting data structure and the information exchange capabilities needed to truly prevent the significant errors that cause harm to patients. Current bedside scanning products have failed to adequately address certain issues thereby limiting their effectiveness in making medication use safer.

Currently, less than 50% of manufacturers' products are bar coded for verification at the point of use, requiring that extensive re-packaging and labeling of products must occur at the institutional level in order to apply needed bar codes. This manual re-packaging and labeling process presents a new opportunity for human error.

Although technical standards exist for bar code formats used in health care and other industries, no regulated standard has existed for what data the manufacturer should provide in the scan code to support safe product use at the bedside.

However, in 1999, the National Coordinating Council for Medication Error Reporting and Prevention (NCC MERP), an independent body comprised of leading national organizations cooperating to address interdisciplinary causes of errors and to promote the safe use of medications, assumed the lead in attempting to assist healthcare in establishing such a data standard. In July 2001, NCC MERP in a document entitled, “Promoting and Standardizing Bar Coding on Medication Packaging: Reducing Errors and Promoting Care” together with the Uniform Code Council published recommended bar code data standards for bar coding of hospital medications by manufacturers. The FDA has recently stated (December 2001) that these recommendations will soon become regulation. However, even if such a standard were regulated, the technical “platform” upon which such a standard would be universally adopted and implemented does not yet exist, and therefore, its adoption by manufacturers and the desired resultant decrease in medication errors will undoubtedly be slow to occur.

Key challenges remain in implementing an effective bedside scanning system for medication safety. For example, the process of updating and maintaining databases of product scan codes, descriptions, and other key product data at the institutional level is currently manual. This manual process must also be repeated for multiple systems in place and, therefore, is labor intensive. Another challenge lies in the fact that, despite the existence of the communication technology such as local area network (LAN) communication, radio frequency communication, and the Internet, there is no system in place to link the manufacturer and the FDA to the patient, who is ultimately receiving the product, for the purpose of medication safe use.

Furthermore, present hospital systems do not keep the caregiver informed of recall information in a timely fashion. Unfortunately, such recall information currently must also be “manually” processed (e.g. entered into the bedside scanning database and/or communicated throughout the institution) at each institution, making it subject to further delay and inaccuracy.

Currently, institutional pharmacies must repackage, label, and bar code medications to compensate for the lack of bar codes on certain manufacturers' product packages, but their approach to this re-packaging and bar coding is incomplete and inconsistent throughout the healthcare industry. For example, in many cases, pharmacies are bar coding products more for the purpose of supporting their own robotic dispensing systems than they are for supporting bedside safety systems. A common result is that only those medications handled by such a robotic system receive bar codes, and bedside scanning to insure safe use of medications is not necessarily occurring.

Additionally, scan codes within the bar codes applied by pharmacies during the re-packaging process typically contain only the original product's NDC or the institution's internal product identification (billing) code. Since control or “batch numbers” assigned to products during the re-packaging process are not included in the bar code, a recall of an entire “batch” found to be re-packaged or labeled in error must be done by manually by examining and retrieving each unit already dispensed to the patient from the patient's medication storage location in the patient care area without any assurance that all recalled doses will be retrieved.

FDA plans to require new NDC numbers in the near future. This translates to new scan codes for every unit of use package size. In effect, there will be tens of thousands of new scan codes to manage every year. There exists a need for a system that will make this management task transparent.

In addition, products mixed or compounded by the pharmacy or another caregiver for a specific patient should contain a unique identifier bar code on each container. Currently, these products are without bar codes because, if unique control or “sequence” numbers were assigned, there is no way to communicate these codes to the bedside scanning system.

Another challenge in implementing an effective bedside scanning system is the current focus on bar coding and scanning medications that have a high degree of use. Too little focus is placed on bar coding and scanning less commonly used medications that have greater potential to cause significant harm or death if administered in error. In effect, all medications must be bar coded and scanned in hospitals to achieve safe medication use, therefore all product information, including scan codes, must be readily available to bedside scanning systems.

There exists a need for one local, hospital-based data source (database) for use by all of these medical product sources to serve as an accessible, shared repository for scan codes for product bar codes. This data source must include the manufacturer's product bar codes, as well as re-packaged product bar codes and patient specific medication bar codes generated by onsite pharmacy systems. Such a database should provide the pharmacist with a single convenient point at which he/she can manage the underlying data that supports safe medication use. Currently, the data management infrastructure to support this need simply does not exist. Despite the fact that technology developments allow for increased information to be imbedded within a bar code, to date there has been no realization of the potential for comprehensive, subscriber accessible product identification and safety information to enhance the quality and reliability of product labeling and administration.

In summary, medication safety in the institutional setting must be targeted at both reducing the number of potential medication errors and eliminating the types of errors that pose the most significant risk to patients. Patients should be safe from injury caused by the healthcare system. This can be achieved if the appropriate underlying data repository and data communication network is established and shared by systems that are designed to support safe use of medications. The product described in this specification will contribute to the creation of this data management infrastructure for healthcare institutions to prevent and mitigate errors.

### SUMMARY OF THE INVENTION

Based on the above it is an object of the present invention to provide an institutional level relational database containing one or more data tables, herein referred to as a Local Medication Scan Code Data Repository (LMSCDR).

Another object of the present system is to provide an Internet-based updating and maintaining means for medical product information from a remote source database via Internet and network data communication. Product information such as recall information is dynamically supplied. The invention includes a programmed computer means for processing and storing medical product information and input and output means interconnected to the programmed system computer means. The input and output means includes a plurality of terminal means located remotely from the programmed system computer means for automatically accessing said database and displaying its information to said user or otherwise using said information to insure accurate and safe use of medications.

The LMSCDR is a data repository containing both manufacturers' scan codes and institutionally-assigned scan codes for medications, admixed solutions, and other products used in administering patient care in the institutional setting, as well as product recall information and company specific data in support of a company's individual product.

Another object of the present invention is to provide a data repository database with product description information that, unlike data presently available from other companies, will be formatted into the data fields required to support pharmaceutical calculations, patient care dosing calculations, determination of equivalencies, proper formatting of text for dosing instructions and directions for use. The LMSCDR will service one healthcare institution, facility, or entity by providing the needed locally accessible product data platform for supporting a bedside scanning system, a system that insures that these products are used safely and appropriately at the point of care.

It is a further object of the present invention to provide an Internet accessible LMSCDR system that accommodates real time receipt of product description, scan code, safety code, and product recall information from a centralized Internet-based data repository.

Yet another object of the present invention is to provide more reliable and safe treatment of patients. These and other objects are achieved by the present invention directed to an institutional level data repository system for medication product information where the system comprises one or more of the following fields or combination of fields: (1) product scan codes, (2) product description information, where the medical product information is specially formatted and designed to support one or more of the items including pharmaceutical calculations, patient care dosing calculations, determination of equivalencies, and proper formatting of text for dosing instructions and directions for use, 3) re-packaging batch identifier codes, 4) re-packaging related product and activity information, 5) solution admixture unique container identifier codes, 6) related product and admixture activity information, 7) product recall information and, 8) company specific data in support of a company's individual product.

The system uses a programmed system computer for processing and storing the medical product information, operatively connected to input and output devices. The input and output devices include a plurality of terminals located remotely from the programmed system computer for automatically accessing the database and displaying its information to a user or otherwise using said information to insure accurate and safe use of medication. The system also has a user access data auditor that provides a user access and activity audit trail.

The invention is further directed to a method for using and creating an institutional level medical product data repository system with the steps of: a) calculating, assigning and storing unique batch or container identifier scan codes for use in a bar code to be affixed to a medical product, b) communicating these codes to a locally-based re-packaging, labeling, and admixture solution system, c) receiving and storing information related to the re-packaging, labeling, and admixture solution activities in association with the scan code in support of a bedside scanning medication safety system, d) providing allowing input of on site recall information for re-packaged or admixed products that have been recalled to prevent administration at the time of use and, e) communicating company specific data in support of the medical product.

The present invention offers significant advantages to the healthcare industry and healthcare providers by providing one location for managing the data needed to support systems associated with medication use safety and one consistent product data source shared by all these systems. The LMSCDR eliminates any need to update and maintain data in multiple systems, making medication safety more achievable and reducing opportunities for manual error. In fact, when used in conjunction with the UMSCDR (Universal Medication Scan Code Data Repository), as described in the patent application by the same inventor filed herewith, it will eliminate most of the manual data management associated with these systems.

The LMSCDR exchanges information at the institutional level with the bedside scanning system as well as systems that are needed to support bedside scanning, such as the unit dose re-packaging and labeling system and the compounding/admixture (e.g. IV solution) tracking and labeling system. Information sharing or exchange is accomplished via client-server relationship or interface (across a local area network, wide area network, the Internet, or by direct cable connection) with these systems.

The system is user-adaptive and may interface with other computer systems such as the pharmacy clinical system that keeps records of medications prescribed for each patient. Batch and container identifier codes are also available to the bedside scanning system making virtually all medications and solutions scannable for patient safety checks. The system includes a user access data auditor that provides a user audit trail.

The system can be used to track essentially unlimited product data. The proprietary databases may be subscriber-accessible for direct release to any persons or entities having a need or desire for the information. Exemplary users of the system may include, for example, consumers, health-care systems (e.g. hospitals, health maintenance organizations, nursing homes), manufacturers, research institutions, health care providers, medical insurance companies, managed care organizations, public health departments, regulatory agencies, attorneys and the like.

Consistent with the invention, the system of the present invention may also be used to receive and store activity data from a bedside scanning system, re-packaging system, and/or admixture system for the purpose of producing a wide variety of reports related to patients and various types of items used in inventory, such as trends and statistical analysis.

The information that may be provided and generated by the database of the present invention is superior in many ways to the limited and generally static product information databases heretofore known in the art.

### BRIEF DESCRIPTION OF THE DRAWINGS

FIG. 1 is a flow chart that embodies the steps of the prior art process for supporting the bedside scanning system scan code database.

FIG. 2 is a flow chart that embodies the preferred steps of the present automated process using the LMSCDR. Generally, the system allows all medications and solutions with bar codes to be scannable for patient safety checks.

FIG. 3 is a flow chart that embodies the Steps of the prior art process for product recall notification.

FIG. 4 is a flow chart that embodies the preferred steps of the present automated product recall notification process using the LMSCDR in association with the UMSCDR.

FIG. 5 is a diagram showing the current medication safety architecture in hospitals comprised of systems for re-packaging, admixture and bedside scanning.

FIG. 6 is a diagram showing the medication safety architecture in hospitals using the LMSCDR (IDentiSafe®).

### DETAILED DESCRIPTION OF THE PREFERRED EMBODIMENT

The preferred embodiment of the present invention provides a local data repository system that includes a pharmaceutical database containing medical product information. The term “medical product” as used herein shall be construed to mean drugs (both prescription and over the counter), including food-supplements, herbal products and vitamins, vaccines, nonvaccine biologicals, medical devices and other medically-related goods and therapies, including plain or admixed solutions and total or peripheral parenteral nutrition. To admix is defined as the process of adding a medication to a solution and the resulting admixture is a container of admixed solution.

For the purposes of the present invention, every individual strength and/or size of a medication is a separate entity. For example, furosemide 20 mg tablets and furosemide 40 mg tablets are separate entities; furosemide 20 mg tablets in unit dose packaging and furosemide 20 mg tablets in a bulk bottle of 100 tablets are separate entities. When the product is a drug, the product may be proprietary or generic. A supply product is defined as a non-medication item used in the process of administering a medication to an institutional patient; every individual strength and/or size of a supply product is a separate entity. A product is any medication or supply product as defined above.

“Bar code” refers to the symbol, as defined by the Health Industry Business Communication Council (HIBCC) or Uniform Code Council (UCC), affixed to a medication or supply product to identify that item to a scanning device; the bar code may also contain additional information such as production lot/batch/unique container identifier code, “use before” or expiration date, and/or safe use or warning codes. To verify other important product information at the time of use, such as a check for product recalls and product expiration, access to more information (product lot numbers and expiration dates) should be available in these scan codes.

The LMSCDR will provide the needed platform for implementing an effective bar code based medication use safety program at the institutional level. The institutional level database is capable of two-way communication with locally based bedside scanning, re-packaging, labeling, and compounding/admixture systems and of receiving additions and updates over the Internet.

One key aspect of the LMSCDR is to serve as a system's master database for product information and tracking of re-packaging activities for locally-based medication re-packaging and labeling systems.

The LMSCDR provides needed data for identifying and verifying the product to be re-packaged based on a scan of the manufacturer's scan code located on the original container at the time of re-packaging.

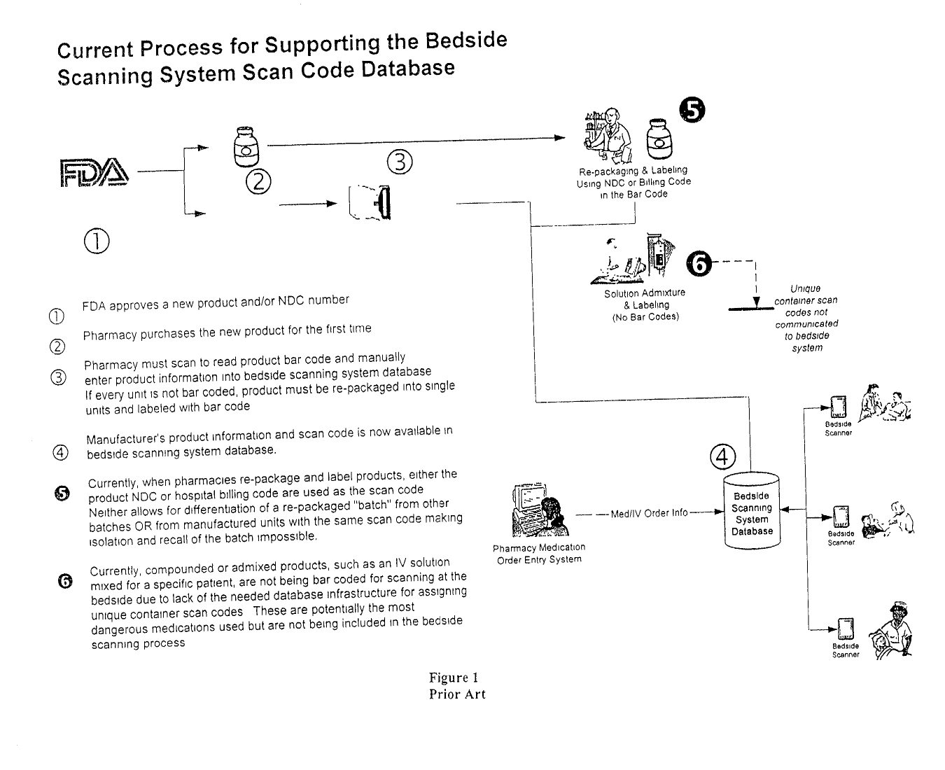

FIG. 1 shows the prior art process for supporting bedside scanning. Under this system the FDA approves a new product (1) and a pharmacy purchases the product for the first time (2). The pharmacy must scan to read the product bar code and manually enter product information into the bedside scanning system database. If every unit is not bar coded, the product must be re-packaged into single units and labeled with a bar code (3). Manufacturer's product information and scan code is now available in bedside scanning system databases (4). Under the prior art system, when pharmacies re-package and label products, either the product NDC or hospital billing code are used as the scan code. Neither allows for differentiation of a re-packaged “batch” from other batches or from manufactured units with the same scan code making isolation and recall of the batch impossible (5). Under the prior art system, compounded or admixed products, such as an IV solution mixed for a specific patient, are not being bar coded for scanning at the bedside due to lack of the needed database infrastructure for assigning unique container scan codes. These are potentially the most dangerous medications used, but they are not being included in the bedside scanning process (6).

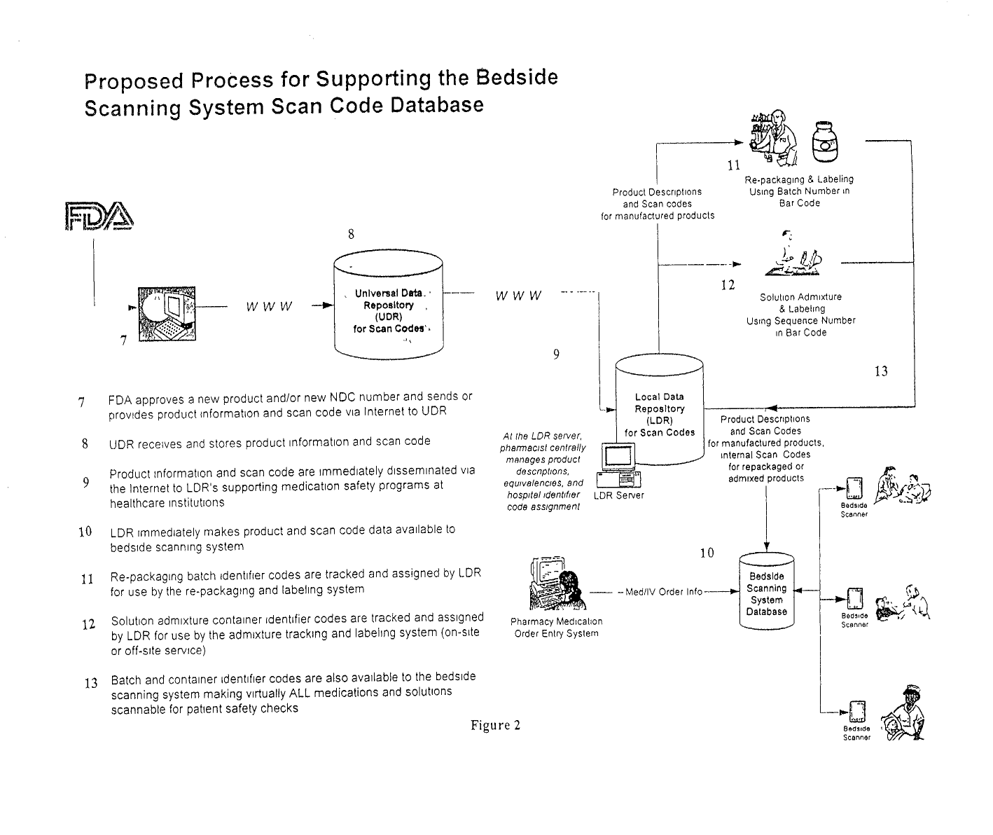

As shown in FIG. 2, the system of the present invention selectively or completely disseminates product information and FDA recall information in a timely fashion (real time or on a designated schedule) via the Internet to institutionally-based (hospital based) local data repositories (e.g., IDentiSafe®) that support and use medication safety systems at healthcare institutions. Under the present system, the FDA approves a new product and this product information and scan code are made available via the Internet to the universal data repository (UDR) (7). The UDR receives and stores product information and scan code. If necessary, product information can be reformatted at this point to insure it supports the needs of hospitals based medication systems (8). The product information and scan code can be immediately disseminated via the Internet to local data repositories (LDRs) supporting medication safety programs at healthcare institutions (9). The LDR immediately makes product and scan code data available to bedside scanning systems (10). Re-packaging batch identifier codes are tracked and assigned by LDR for use by the re-packaging and labeling system (11). Solution admixture container identifier codes are tracked and assigned by LDR for use by the admixture tracking and labeling system (on-site or off-site service) (12). Batch and container identifier codes are also available to the bedside scanning system making virtually all medications and solutions scannable for patient safety checks (13).

FIG. 2 shows that the LMSCDR is capable of generating and tracking unique “batch” identifier codes for on-site pharmacy re-packaging activities (11)(13). In practice, for multiple units (doses) packaged, when packaging or labeling errors occur, all can be selectively recalled from use when scanned. The system also communicates the batch identifier code to the packaging and labeling system for inclusion in the label bar code other product ID technology to be used. ID technology refers to any scanning or proximity technology including bar code, proximity chip, Bluetooth, or other that is affixed to or implanted in a product or its packaging and is used to identify the product for the purpose of inventory tracking and/or safe and appropriate use.

The LMSCDR is capable of tracking all information associated with a “batch” re-packaged and relabeled product, including:

Manufacturer's original product scan code (associated with the product description and other product information via the relational database structure)

Date and time of re-packaging

Original manufacturer's lot number and expiration date

Expiration date of the re-packaged product (based on established laws and practice standards

Person (e.g. pharmacist, pharmacy technician or other person qualified by state law) responsible for checking the re-packaged and labeled product before being placed into use

Licensed facility/pharmacy where re-packaging is performed Compounding/admixture services for mixing and labeling solutions for institutionalized patients may be located on-site at the facility or off-site, such as when a third party contracted service (“outsourcing”) is used. In either case, the LMSCDR will also serve as a master database for product information and tracking of admixing activities for solution admixture and labeling systems.

The LMSCDR provides the needed data for identifying and verifying the products (solutions and additive medication components) to be admixed based on a scan of the manufacturer's scan code located on the original container. The system is capable of assigning and tracking a unique admixture “unique container identifier” code for every patient-specific admixture. A unique container identifier code is a unique numeric or alphanumeric code assigned to a specific container of a compound product, such as an admixed IV solution, within a hospital. This code identifies the unique container, allowing other technologies to associate it with its proper ingredients and with the patient for whom it was intended. Within the LMSCDR database, each unique container identifier code is uniquely associated with a single solution container; associated with or contains a specific patient identification code and, more specifically, a medical order for that patient. The system communicates this unique container identifier code to the admixture labeling system for inclusion in the label bar code or other product ID technology to be used (12).

The LMSCDR tracks product information related to all components (base solutions, additive drugs, and supplies used) of the admixed solution, including:

Manufacturer's original product scan code (associated with product description and other information via the relational database structure)

Date and time of admixing

Original manufacturer's lot number and expiration date for each product contained in or used in preparing the admixture

Date and time of day of expiration of the admixed container (based on established laws and practice standards)

Person (e.g. pharmacist, pharmacy technician or other person qualified by state law) responsible for admixing and labeling

Person (e.g. pharmacist, pharmacy technician or other person qualified by state law) responsible for checking the admixed and relabeled product before being placed into use

Licensed facility/pharmacy where admixing is performed

The system requires a programmed system computer means for processing and storing the medical product information. The means for updating and maintaining the medical product information is a remote source database via network data communication that dynamically supplies the product information. Means for both input and output of the medical product information are operatively interconnected to the programmed system computer. The input and output means include a plurality of terminals located remotely from the programmed system computer means for automatically accessing the database and displaying its information to the user or otherwise using said information to insure accurate and safe use of medications in real time. A user access data auditor provides a user access audit trail.

The LMSCDR data repository may reside on the hospital wide area network (WAN) or local area network (LAN) server with Internet access available. The operating system for the present invention is preferably a windows-based system such as Microsoft Corporation's Windows NT™ or Windows 2000™ environment, a UNIX™ based system, or a LINUX™ based system running on the Internet that supports the latest releases of internet browsers. The input means for the operating environment is preferably mouse-driven keyed digital or scanned inputs and may optionally employ voice-activated technology, touch screen, or wireless hand-held terminals. In an alternative embodiment, the system integrates input means such as wireless mobile computing and bar code data capture using a wireless Internet appliance capable of collecting data and transmitting both voice and data packets (i.e., dataphones). Such devices act a web clients, handheld computers, bar code scanners and telephones and enable users to make and receive phone calls, enter and submit data to a remote server, and scan a bar code for data capture.

Although wireless electromagnetic transmissions in the radio frequency range are the preferred embodiment, alternate types of wireless electromagnetic transmissions might be utilized, e.g., infrared and the like.

Furthermore, in accordance with an alternative embodiment of the invention, the system may instead utilize a multi-point control unit (MCU) where video conferencing systems are interconnected.

To use the database to calculate a dosage recommendation, including an amount and a frequency of administration of a medical product, inputs may be provided from different sources and input means include any of the above.

Currently available software packages can provide the interface between the bar code reading device and the personal computer. This software can be configured to receive the input signals from the bar code reader.

The medical product description database shown in the present invention is designed for implementation via output means consisting of a computer, for example, but not limited to a personal computer, workstation, mini computer, mainframe computer, or such as physically compact, portable, user-interface devices such as small portable personal computers, especially hand-held devices known as personal digital assistants. Alternative output means include telephone interfaces incorporating modems and other equipment to accomplish digital and audio communication. Those skilled in the art will understand that the system can readily be used on or adapted to other hardware platforms.

The system may “seamlessly” interface with preexisting hospital pharmacy and patient information systems for access to medication profile records, admission, transfer and discharge information, and other pertinent patient specific information such as allergies, adverse drug reaction reports, and all medication record annotations, including therapeutic interventions, and other documentation. Alternatively, the data may be concatenated from a plurality of databases, including a pharmacy database, a medication and diagnosis database, a treatment plan database or other database, which may include lab test information, practice information, inpatient status and location or billing and appointment information.

While the present disclosure provides implementation of the system within an Internet based system, the system may be implemented in connection with other mediums, such as, for example, but not limited to, local area network (LAN) or wide area network (WAN), or via a transmitting or receiving device such as, but not limited to, a modem. In other embodiments, other types of input means and output means may be used.

In an alternative environment, the operating system is PALM. Similarly, a dual-platform design for either PALM or Windows operating system may be used.

The present invention is embodied in the form of computer program code embodied in tangible media, such as floppy diskette, read only memories (ROMs), CD-ROM, hard drive, ZIP™ drive, JAZ™ drive, or another other computer-readable storage medium.

The system uses SQL database, Java, ESP, JSP, XML (eXtensible Markup Language) and Hypertext Markup Language (HTML) code and protocol, uses TCP/IP socket programming, and uses secure socket layer (SSL) encryption where required for security. Security features include firewall security, and user logon name and password management employing a high level of physical security.

The product data database involves strict Internet security standards meeting or exceeding those used by the banking or similar industries. Preferred embodiments of the invention achieve this desirable result by providing a logon name and password verification supported by transparent connectivity. In an alternative embodiment, biometric recognition of personal user characteristics including voice and handwriting patterns, fingerprints, and retinal scans may be employed as the medium for accepting user inputs. Future developments such as more accurate and efficient bio-pattern recognition techniques may allow future embodiments of the present invention to include biopattern recognition techniques for security.

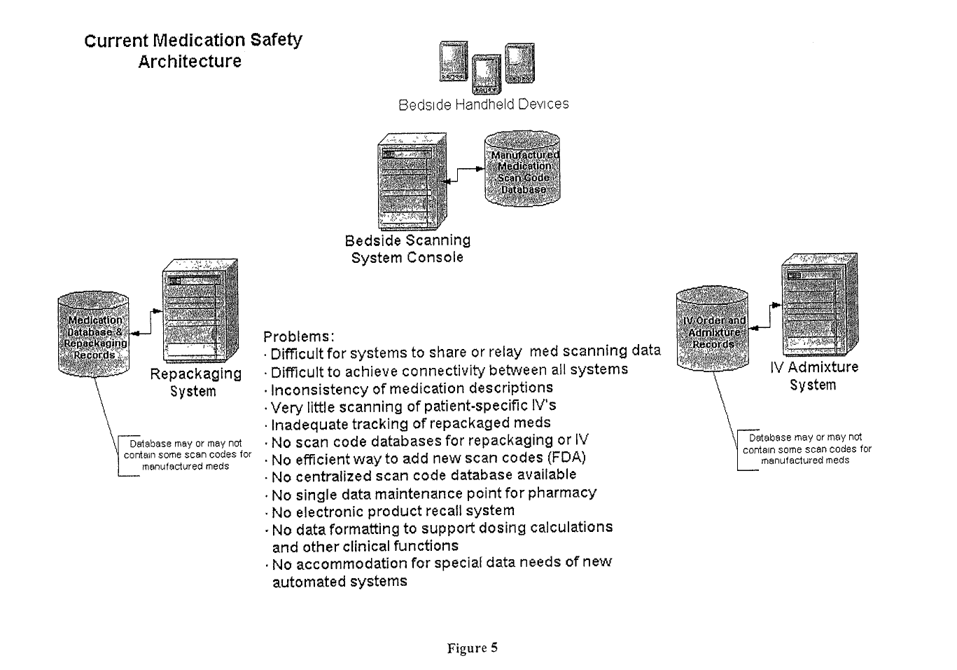

FIG. 5 shows the hospital's current medication safety architecture comprised of systems for re-packaging, IV admixture and bedside scanning that are stand alone. These systems have no direct connectivity and do not share a common data source. There is no network for ongoing product information updates from external sources.

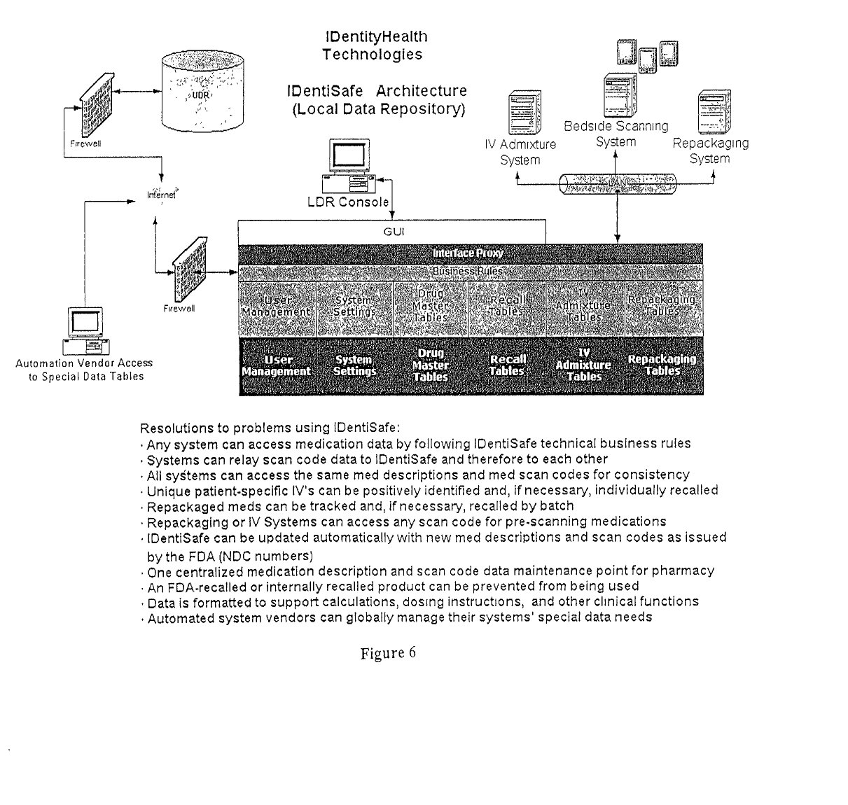

FIG. 6 shows the hospital's medication safety architecture using the LMSCDR. The re-packaging, IV admixture and bedside scanning systems are all connected to a common database, the LMSCDR, for sharing access to all required data. Business rules are defined to allow these systems to interact with the LMSCDR. The LMSCDR receives updates automatically from the UMSCDR across the Internet. Security means, such as firewalls, are in place to prevent unauthorized access to the medication data. Automation vendors may have restricted access to special tables in the UMSCDR for updating and disseminating required product-specific medication data to its own installed customer systems.

The LMSCDR data repository can be incorporated into the institutions medication safety architecture in one of two ways:

In one such way the data repository becomes the database that is accessed by bar code-enabled systems as the source of product-specific information, including product scan code, lot number, expiration date/time, “safety codes”, re-packaging “batch” identifier codes and associated product information, admixture “unique container identifier” codes and associated admixture contents, and product recall information.

In an alternative way, the data repository interfaces to the bar code-enabled system database across a local area network, wide area network, the Internet, or by direct cable connection to “feed” needed data to that system.

In either case, the LMSCDR will not be designed to store and manage patient specific information related to patients and patient medication orders. This function will remain with the bedside scanning system. The LMSCDR will instead compliment existing bedside scanning systems by providing the missing data infrastructure needed for medication identification to prevent errors. Future iterations of the LMSCDR may, however, be used as a steppingstone for relaying this information between systems for efficient use of connectivity.

The LMSCDR will contribute to the implementation of recently established recommended data standards, anticipated to soon be required by regulation, to support safe medication use, since it will provide the local foundation for the standard data to be used for product identification, control, and tracking.

Accessibility via the Internet allows for receipt of real time product information and product recall information electronically from a Universal Medication Scan Code Data Repository (UMSCDR) as described in the co-owned patent application filed herewith. The UMSCDR can be updated in real time by IdentityHealth Technologies®, the FDA, product manufacturers or a similar subscribing company that wishes to disseminate needed product specific data, and that data is automatically passed to installed LMSCDRs at local sites.

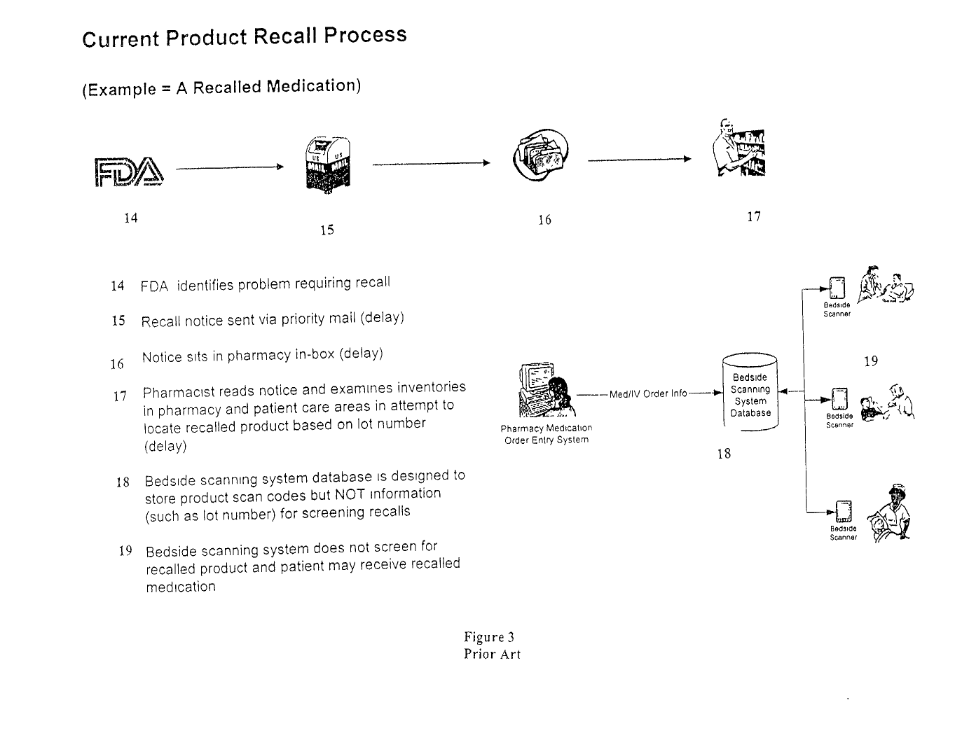

Under another aspect of the invention, FIG. 3 shows the prior art product recall process where bedside scanning systems do not screen for recalled products (19). Rather, FIG. 3 shows a process where the FDA identifies a problem requiring a recall (14). A recall notice is then sent via priority mail, email, or web site posting, creating a delay (15). The notice then awaits action by the pharmacy resulting in further delay (16). An additional delay occurs when the pharmacist reads the notice and examines inventories in pharmacy and patient care areas in an attempt to locate recalled product based on the lot number (17). Under the prior art recall process, the bedside scanning system database is designed to store product scan codes but not information (such as lot number) for screening recalls (18). Further, the bedside scanning system does not electronically screen for recalled product and the patient may receive recalled medication (19).

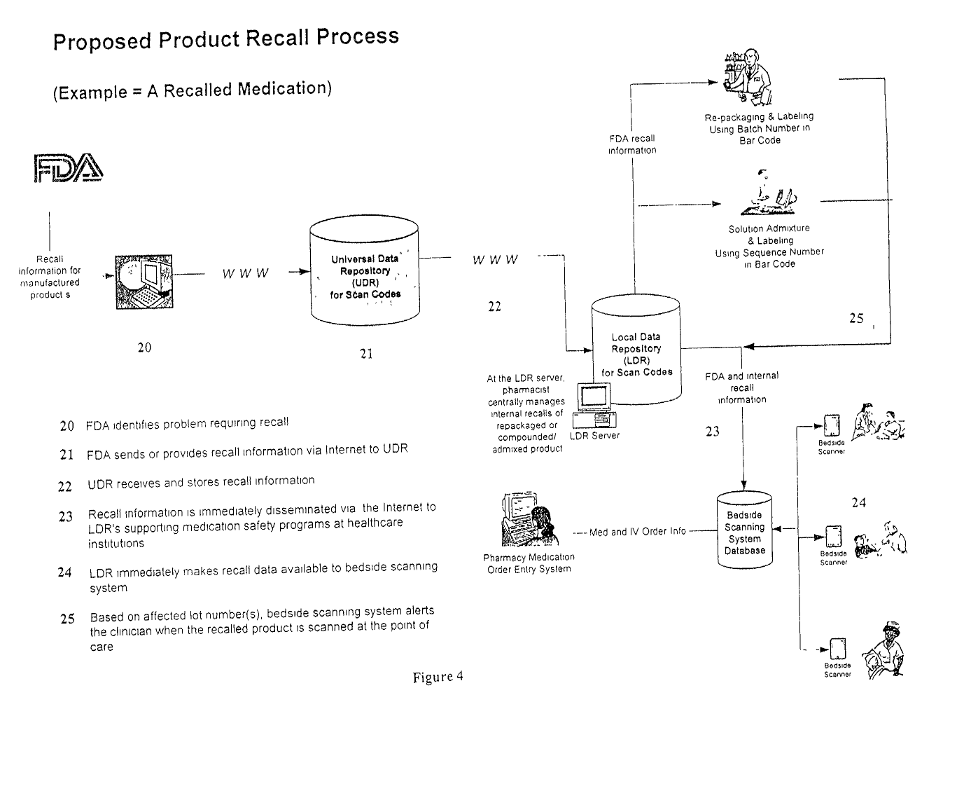

FIG. 4 shows that the system of the present invention streamlines the recall notification process and makes recall information important to the medication process easily available. Under the product recall process of the present invention, the FDA identifies a problem requiring recall (20). Here, the FDA sends or provides recall information via the Internet to the UDR (or UMSCDR) (21). The UDR receives and stores recall information (22). Recall information is immediately disseminated via the Internet to LDR's (or LMSCDR's) supporting medication safety programs at healthcare institutions (23). The LDR immediately makes recall data available to bedside scanning systems (24). The lot number is the identifier used in the event of a recall that, in association with the scan code, identifies each manufacturing batch. Via the lot number, those lots subject to recall are readily identified and are available to the bedside scanning system, re-packaging systems, and admixture systems (24). Based on the affected lot number(s), the bedside scanning systems alert the clinician when the recalled product is scanned at the point of care (25). Additionally, inclusion of the expiration date in the scan code ensures that the patient does not receive a medication that is beyond its expiration date.

The system includes a user access data auditor which tracks whether or not the recall message has been viewed. The data auditor provides a user data access audit trail.

In its most preferred embodiment, the LMSCDR is a locally-based centralized data repository capable of storing some or all of the following information

(a) Product data received electronically or input and maintained manually, including some or all of the following:

Scan codes for manufactured products (scan code is defined as the data contained in the ID technology that uniquely identifies the medication or supply product; the scan code may also contain other pertinent information such as the National Drug Code (NDC) or Global Trade Identification Number (GTIN) or Universal Product Code (UPC), traceable manufacturing or re-packaging information (lot identifier code), “use before” or expiration information (including year, month, day, hour and minute of valid use expiration).

Identification data for manufactured products formatted to support pharmaceutical calculations, determination of equivalencies, patient care dosing calculations, proper formatting of text for dosing instructions and directions for use.

Product “safety codes” (safe use or warning codes are codes assigned to the medication or supply product to trigger information and/or warnings at the point of use that contribute to insuring its safe use; e.g., a code that immediately identifies that a particular drug must not be given by direct intravenous injection) (safety codes are currently non-existent but are recommended by experts).

Product recall information for FDA recalls, including data for identifying the product (scan code, NDC or other), lot number(s) recalled, reason(s) for recall and severity of recall.

(b) Pharmacy on-site re-packaging information received electronically and directly from a re-packaging and labeling software system or input and maintained manually including some or all of the following data elements:

a Complete product description

Original manufacturer's scan code

Manufacturer's original lot number and expiration date

Re-packaging batch identifier code

Quantity per package

Number of packages processed

Time/date of re-packaging

Expiration date of re-packaged product

Identification of employee who performed the packaging and labeling

Identification of pharmacist who performed the final check of packages

(c) Solution admixture preparation information received electronically and directly from a solution admixture tracking and labeling software system or input and maintained manually including some or all of the following data elements:

Code to identify where admixture and labeling took place (e.g. Pharmacy, Nursing unit, off-site admixture service, other)

Ingredients used and amount of each

Manufacturer's original lot number and expiration date of each ingredient

Unique container identifier code and/or pharmacy system order number to associate the container with a specific patient and/or medication order and to support proper sequential use of containers when applicable

Date and exact time of day of admixing

Date and exact time of day of expiration (“begin infusion before”)

Identification of employee who performed the admixing and labeling

Identification of pharmacist who performed the final check

(d) Institutional level product recall information, including data for identifying recalled batch identifier code(s) (or unique container identifier code(s))—a numeric or alphanumeric code assigned to each package for a multi-package re-packaging process within a hospital pharmacy. This code identifies the package as one re-packaged as part of a specific re-packaging event and may include such information as the involved product identifier (scan code, NDC or other), the reason(s) for recall and/or the severity of recall.

(e) Specific data tables required by individual technology company systems that can be updated by that company or a company's designee via portal to the UMSCDR for maintaining their system-specific data. For example, a re-packaging system may require assignment of specific package dimensions for individual products, and these dimensions can be uniformly disseminated to all installed locations of that company's re-packaging system.

The LMSCDR will be installed at an institution in one of two ways making it accessible to other systems throughout the institution: either installation directly onto the institution's LAN or WAN server or, alternatively, in another embodiment of the invention, onto a dedicated server computer that is networked via LAN, WAN, or Internet to the institution's network. In addition, the LMSCDR will be accessible over the institution's network to other systems such as bedside scanning systems, re-packaging systems, and solution admixture tracking systems.

The medical product information is concatenated from a plurality of databases such as locally-based re-packaging, labeling, and compounding/admixture systems, a pharmacy database, a medication and diagnosis database, a treatment plan database, a lab test information database, practice information, inpatient status and location or billing and appointment information.

The accessibility can be a client server relationship where the LMSCDR “server” database is accessed directly as if it were a database residing on the “client” system or, alternatively, an interface relationship where the LMSCDR sends data to and receives data from the other system's databases.

The LMSCDR is designed with a friendly graphical user interface (GUI) for performing setup and routine functions. These functions include:

Activating or deactivating drug products in the database to create a custom formulary data table for the institution

A central database for assigning institutional billing codes to products as part of the product information

Entering or editing product equivalency settings as part of the product information

Creating multiple custom product descriptions for each product that can be used by linked systems with specific description requirements

Manually entering manufacturer product identification or recall information if required

Manually initiating internal hospital recalls of products by batch or unique container identifier code

Alerts inform the system administrator of new product information or recall information received from the UMSCDR and differentiates between formulary and non-formulary products

Settings to define preferred processing of recalls by class, such as the option to review and authorize recalls before the information is disseminated to connected systems and to the end user and immediate dissemination to connected systems and to the end user

One or more data administrators will manage controlled access to the LMSCDR database and supportive software, employees of the institutions assigned the responsibility for maintaining the data and user access. Such access will require logon identification code and password and/or other physical or biometric identifications means.

Medication re-packaging and solution admixture records can be manually entered into the LMSCDR. Alternatively, they may be received via interface from a re-packaging or labeling software system; received via interface from an on-site solution admixture tracking or labeling software system; or received via interface over the Internet from an off-site admixture tracking software system.

The following are examples of various functions that can be performed by the institution's LMSCDR data administrator using the present system.

1. To add another user the data administrator will log on; indicate that a new user is to be added; enter the user's name; assign the user a logon name and initial password (must be changed at first login); assign privileges such as the ability to:

Add/edit users

Activate/deactivate items for formulary status

Enter/edit batch or unique container identifier code recalls

Review and authorize processing of new information from manufacturers, such as new product data or recalls

Access system communication settings

2. To activate a new product to make it part of the institution's formulary database table the data administrator will log on; indicate that a product needs to be activated; search for and select the product; toggle the product to active status, making it eligible to be scanned within the institution; assign the institutional identification or billing code to the product; assign safety codes if desired to provide special warning information prior to administration, e.g. Drug Must Be Diluted Before Use; save the data.

3. To manually enter batch or unique container identifier code information the data administrator will log on; indicate that a batch or unique container identifier code needs to be assigned; the database will assign the next available number in either case; enter all required information on the batch (of re-packaged product) or sequence (solution container) to be produced; save the data.

4. To manually enter recall information the data administrator will log on; indicate that a batch or unique container identifier code recall needs to be initiated; enter the parameters-such as batch or unique container identifier code(s) to be recalled; enter the reason code(s) for recall; enter the severity code for recall; save the data.

5. To approve incoming data on new products the data administrator will log on; review new product data; determine whether the product should be given active or inactive formulary status; save the data.

6. To process incoming data on recalls the data administrator will log on; review recall data for active (formulary) and inactive products; determine if data is pertinent to the institution; print pertinent data for use by staff members who will find and remove the affective product lot from inventory; activate pertinent recalls for automated screening at the time of packaging, admixture, or administration to a patient. The system will perform a check for scan code duplication and, if required, appropriate notification of such will be provided to the data administrator. The data administrator will then save the data.

Companies that use or provide various systems will subscribe to and be charged fees for using the LMSCDR in support of their product's compliance with the institution's medication safety program. These systems may include bedside scanning systems for medication safety at the bedside; pharmacy re-packaging/re-labeling systems; admixture systems or services; and/or other pharmaceutical compounding services.

Hospitals will subscribe to services for ongoing, automatic update of the database with new medication description and scan code information, as well as product recall information.

Thus, the database of the present invention achieves the above stated objectives, eliminates many of the difficulties encountered in the use of prior systems, solves problems and attains the desired results described herein.

All references cited herein, including journal articles, published or corresponding U.S. or foreign patent applications, issued U.S. or foreign patents, or any other references are entirely incorporated by reference herein.

In the foregoing description certain terms have been used for brevity, clarity and understanding. However, no unnecessary limitations are to be implied therefrom because such terms are for descriptive purposes and are intended to be broadly construed. Moreover, the descriptions and illustrations given are by way of examples and the invention is not limited to the exact details shown or described. In addition, any feature of the invention that is described in the following claims as a means for performing a function shall be construed as encompassing any means capable of performing the recited function and shall not be limited to the means disclosed in the foregoing description or any mere equivalent thereof.

Having described the features, discoveries and principles of the invention, the manner in which it is construed and utilized and the advantages and useful results obtained, the new and useful elements, arrangements, systems, equipment, operations, methods and relationships are set forth in the appended claims.

I claim:

1. An institutional level data repository system for medication product information, said system comprising:
a) a database containing medical product information comprising one or more of the following fields or combinations of fields:
i) product scan codes;
ii) product description information including NDC number; wherein said medical product information is specially formatted and designed to support one or more of the items including pharmaceutical calculations, patient care dosing calculations, determination of equivalencies, and proper formatting of text for dosing instructions and directions for use;
iii) re-packaging batch identifier codes;
iv) re-packaging related product and activity information;
v) solution admixture unique container identifier codes;
vi) related product and admixture activity information;
vii) product recall information;
viii) company specific data in support of a company's individual product;
b) a user access data auditor which provides a user data access audit trail;
c) a programmed system computer for processing and storing said medical product information;
d) an input device operatively interconnected to the programmed system computer means;
e) an output device operatively interconnected to the programmed system computer means;
f) said input and output devices including a plurality of terminals located remotely from the programmed system computer for automatically accessing said database and displaying it to a user.

2. The system of claim 1, further comprising an Internet connection for updating and maintaining medical product information from a remote source database via network data communication, said connection dynamically supplying and automatically updating said product information.

3. The system of claim 1, further comprising an Internet connection for updating and maintaining product recall information from a remote source database via network data communication, said connection dynamically supplying and automatically displaying or otherwise using said product recall information to prevent the use of a recalled product.

4. The system of claim 1, where said medical product information is concatenated from a plurality of databases selected from the group consisting of a locally-based re-packaging, labeling, and compounding/admixture system, a pharmacy database, and a medication database.

5. The system of claim 1, further comprising a two-way communication means with a locally-based re-packaging, labeling, and compounding/admixture system.

6. A method for using and creating an institutional level data repository system for medical product information, said method comprising the steps of:
a. calculating and assigning unique batch or container identifier codes to a medical product;
b. communicating said codes to a locally-based re-packaging, labeling, and admixture solution system;
c. receiving, storing and tracking information related to the re-packaging, labeling, and solution admixture activities in support of a bedside scanning medication safety system;
d. providing product recall information on re-packaged or admixed products that have been recalled to prevent administration at the time of use; and
e. communicating company specific data in support of the medical product.

7. The method of claim 6, further comprising the step of manually entering data using a bar code reader and scanning a bar code on a medication.

8. The system of claim 1, wherein at least one of said input and output devices comprises a computer display screen having said medical product information displayed in fields.

9. The system of claim 1, comprising a source-oriented patient specific data-retrieval subsystem, said data retrieval subsystem being connected to access at least one data-retrieval network to retrieve product description and identification information and patient-related data to the point of care from at least one remote source database.

10. The system of claim 1, wherein at least one of said input and output devices is coupled to a voice recognition unit for permitting said user to communicate with said system by means of verbal inputs.

11. The system of claim 1, wherein said input means further comprises a stylus interface for permitting said user to communicate with said system by writing on said screen with a stylus.

12. The system of claim 1, wherein information is received in said database input and output devices which utilize one or more of the items taken from the group comprising voice, keyboard, pen and mouse.

13. The institutional level data repository system of claim 1, wherein said medical product information relates to products taken from the group consisting of generic, brand, over-the-counter, biologicals, blood products, medical devices, admixed solutions and total and peripheral parenteral nutrition.

14. The method of claim 6, further comprising the steps of retrieving medical product information across a network from a remote source database and displaying or allowing access to retrieved product information in real time.

15. The method of claim 6, wherein said product recall information includes previously known product recall data associated with the product.

16. The method of claim 6, further comprising means for receiving and storing messages relating to product recalls, said messages being automatically displayed to a user at the point of use or upon the identification of said user.

17. The method of claim 6, further comprising means for receiving and storing messages relating to product recalls, said messages consisting of data comprising at least one of the items selected from the group consisting of: identification of the product, lot number of the product, reason(s) for recall and severity of recall.

18. The method of claim 6, further comprising the steps of reading the identifier code of a dispensed package with a code reader and verifying that the requested package was properly dispensed.

19. The method of claim 18, wherein the step of verifying the requested package was properly dispensed comprises comparing the code read by the code reader to a reference code.

20. The system of claim 1, further comprising a program operable to use said medical product database and patient specific information to calculate a dosage recommendation, including an amount and a frequency of administration of said medical product.

21. The system of claim 1, further comprising communication media for said database containing medical product information to be used with other systems within a local area network.

22. The system of claim 1, further comprising communication media for said database containing medical product information to be used with other systems in a client server architecture.

23. The system of claim 1, further comprising communication media for said medical product information database to support a bedside scanning system for medication safety.
